(19) United States
(12) Patent Application Publication
(10) Pub. No.: US 2012/0233242 A1
(43) Pub. Date: Sep. 13, 2012

(54) E-Book Service That Includes Users' Personal Content

(75) Inventors: Abraham Phelps Murray, Scituate, MA (US); Stavan Mahendra Parikh, San Jose, CA (US); Gopal Venu Vemula, San Jose, CA (US)

(73) Assignee: GOOGLE INC., Mountain View, CA (US)

(21) Appl. No.: 13/046,504

(22) Filed: Mar. 11, 2011

(51) Int. Cl. G06F 15/16

(52) U.S. Cl. 709/203

(57) ABSTRACT

Users can access personal content on multiple e-book readers. A personal document received from a user is converted from its original format into a shadow e-book of an e-book format. An e-book record is created for the personal document to store information for creating a seamlessly integrated reading experience of the shadow e-book across different e-book readers (e.g., reading position, notes). When an e-book reader requests for the personal document, the shadow e-book is transmitted to the e-book reader along with information from the e-book record. Subsequently, information is received from the e-book reader to update the e-book record.

### TECHNICAL FIELD

The disclosure generally relates to the field of electronic publication, in particular to services providing electronic publications to users.

### BACKGROUND

As electronic books (also called “e-books”) gain popularity, more and more users are reading e-books, often on multiple e-book readers (e.g., software applications such as the GOOGLE READER application, and hardware reading devices such as the AMAZON KINDLE™). Existing e-book services allow users to read purchased e-books on designated e-book readers, and do not allow users to access their own content across multiple e-book readers, thus inconveniently limiting the users to accessing personal content through only a single e-book reader.

### SUMMARY

In accordance with one embodiment, a computer-implemented method for accessing a personal document of a user on a plurality of electronic book (“e-book”) readers, including: providing the personal document to a first e-book reader in response to receiving a request for the personal document from the first e-book reader; receiving reading experience information for the personal document from the first e-book reader; and providing the personal document and the reading experience information to a second e-book reader in response to receiving a request for the personal document from the second e-book reader.

In accordance with another embodiment, a computer system for accessing a personal document of a user on a plurality of electronic book (“e-book”) readers, including: a computer-readable storage medium including executable computer program code for: providing the personal document to a first e-book reader in response to receiving a request for the personal document from the first e-book reader, receiving reading experience information for the personal document from the first e-book reader, and providing the personal document and the reading experience information to a second e-book reader in response to receiving a request for the personal document from the second e-book reader; and a processor for executing the executable computer program code.

In accordance with still another embodiment, a non-transitory computer-readable storage medium storing executable computer program instructions for accessing a personal document of a user on a plurality of electronic book (“e-book”) readers, the computer program instructions including instructions for: providing the personal document to a first e-book reader in response to receiving a request for the personal document from the first e-book reader; receiving reading experience information for the personal document from the first e-book reader; and providing the personal document and the reading experience information to a second e-book reader in response to receiving a request for the personal document from the second e-book reader.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

FIG. 1 is a high-level block diagram of a computing environment according to one embodiment.

FIG. 2 is a high-level block diagram illustrating an example of a computer for use in the computing environment shown in FIG. 1 according to one embodiment.

FIG. 3 is a high-level block diagram illustrating modules within a server shown in FIG. 1 according to one embodiment.

FIG. 4 is a flow diagram illustrating a process for permitting users to access personal contents among multiple e-book readers, according to one embodiment.

### DETAILED DESCRIPTION

The figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

### System Environment

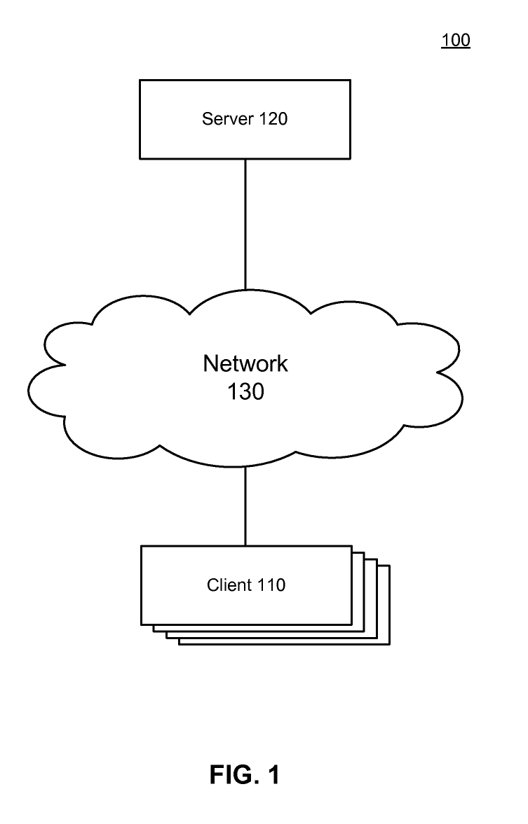

FIG. 1 is a high-level block diagram that illustrates a computing environment 100 for permitting users to access their own contents on multiple e-book readers, according to one embodiment of the present disclosure. An e-book reader is a software application and/or electronic device designed primarily for the purpose of reading e-books. Example software e-book readers include GOOGLE READER and MICROSOFT READER applications. Example hardware e-book readers include the AMAZON KINDLE™ and BARNES AND NOBLE NOOK™. An e-book is a text and/or image based publication in digital form that can be read on an e-book reader. There are a variety of e-book formats used to create and publish e-books, such as electronic publication (ePub), hypertext markup language (HTML), and extensible markup language (XML). As shown, the computing environment 100 includes multiple clients 110 and a server 120 connected through a network 130. There can be other entities in the computing environment 100 as well.

A client 110 is a hardware e-book reader or an electronic device that runs a software e-book reader application for viewing e-books retrieved from the server 120 through the network 130. An example electronic device is a mobile telephone executing, for example, a GOOGLE ANDROID operating system (OS). Other examples of the electronic device include a conventional computer system executing, for example, a MICROSOFT WINDOWS-compatible OS, Apple OS X, and/or a Linux distribution, and a device having computer functionality, such as a personal digital assistant (PDA) and a video game system. A software e-book reader often is developed specifically for a type of electronic device and/or OS. For example, an e-book reader applet may be developed specifically for the GOOGLE ANDROID OS. A user may have multiple clients 110 (e.g., a desktop computer in the office, a laptop at home, and a mobile telephone), and use e-book readers running on these clients 110 to read e-books retrieved from the server 120.

The server 120 is a hardware device and/or software program configured to provide a web-based e-book service that allows users to access a large collection of published e-books on a variety of supported e-book readers. In addition, the server 120 permits a user to access the user's own content as e-books on any of that user's e-book readers. In one embodiment, in order to provide the user with a seamlessly integrated reading experience of e-books across different e-book readers, the server 120 synchronizes the reading position, notes, and other related information among the e-book readers. In one embodiment, the server 120 also provides a web-based data storage service that allows users to upload, create, and/or share personal documents online.

One or more of the services (or functions) provided by the server 120 can be executed in a cloud computing environment. As used herein, cloud computing refers to a style of computing in which dynamically scalable and often virtualized resources are provided as a service over the Internet. Thus, cloud computing customers generally do not own the physical infrastructure serving as host to the software platform in question, but instead rent usage of resources from a third-party provider, where consume these resources as a service and pay only for resources used.

The network 130 is a system of interconnected computer networks that use standard communications technologies and/or protocols to facilitate data transmission among the computer networks. Thus, the network 130 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 130 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 130 can be represented using technologies and/or formats including the hypertext markup language (HTML), the extensible markup language (XML), JavaScript, VBScript, Flash, PDF, PostScript, etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above.

### Computer Architecture

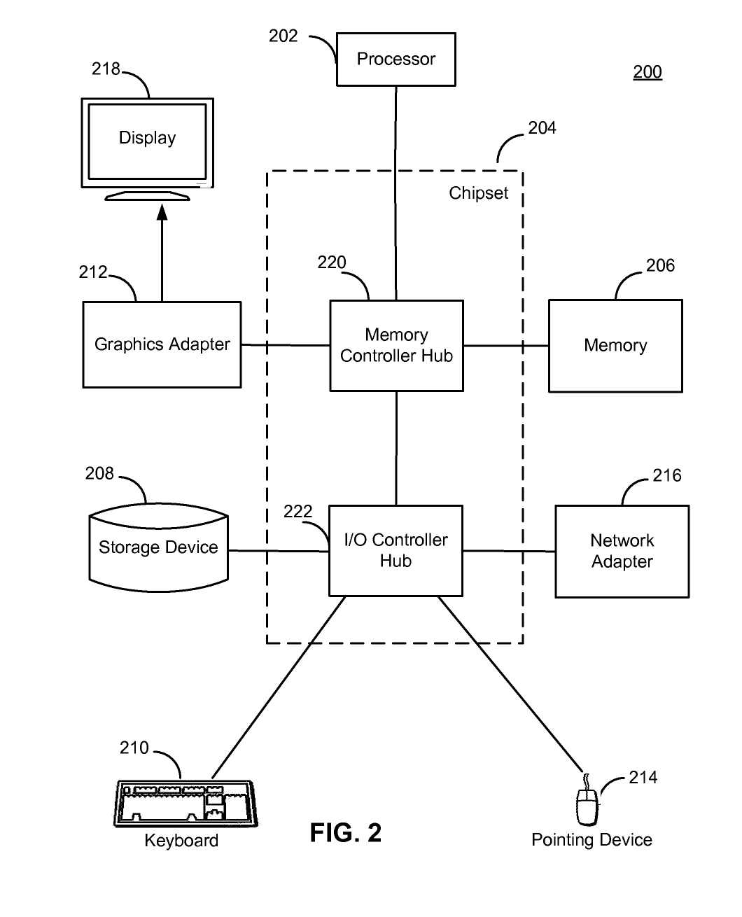

The entities shown in FIG. 1 are implemented using one or more computers. FIG. 2 is a high-level block diagram illustrating an example computer 200. The computer 200 includes at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display 218 is coupled to the graphics adapter 212. A storage device 208, keyboard 210, pointing device 214, and network adapter 216 are coupled to the I/O controller hub 222. Other embodiments of the computer 200 have different architectures.

The storage device 208 is a non-transitory computer-readable storage medium such as a hard drive, compact disk read-only memory (CD-ROM), DVD, or a solid-state memory device. The memory 206 holds instructions and data used by the processor 202. The pointing device 214 is a mouse, track ball, or other type of pointing device, and is used in combination with the keyboard 210 to input data into the computer 200. The graphics adapter 212 displays images and other information on the display 218. The network adapter 216 couples the computer 200 to one or more computer networks.

The computer 200 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 208, loaded into the memory 206, and executed by the processor 202.

The types of computers 200 used by the entities of FIG. 1 can vary depending upon the embodiment and the processing power required by the entity. For example, the server 120 might comprise multiple blade servers working together to provide the functionality described herein. As another example, the client 110 might comprise a smartphone with limited processing power. The computers 200 can lack some of the components described above, such as keyboards 210, graphics adapters 212, and displays 218.

### Example Architectural Overview of the Server

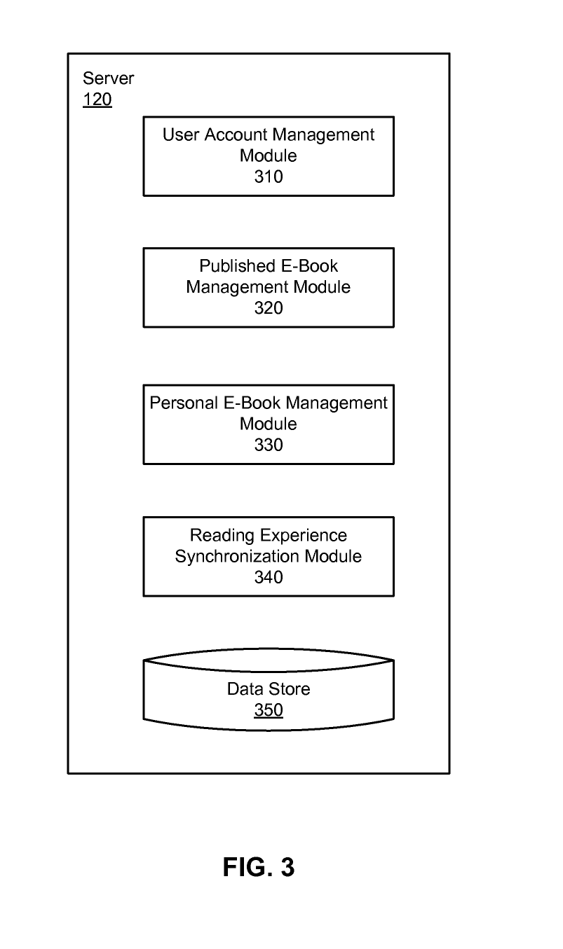

FIG. 3 is a high-level block diagram illustrating a detailed view of modules within the server 120, according to one embodiment. Some embodiments of the server 120 have different and/or other modules than the ones described herein. Similarly, the functions can be distributed among the modules in accordance with other embodiments in a different manner than is described here. In addition, each module in FIG. 3 may be implemented by a set of computers operating in parallel to further improve efficiency. As illustrated, the server 120 includes a user account management module 310, a published e-book management module 320, a personal e-book management module 330, a reading experience synchronization module 340, and a data store 350.

The user account management module 310 manages user accounts of the e-book service provided to users by the server 120. In order for a user to enjoy the e-book service, that user is required to first establish a user account with the server 120. The user can then log into the user account using an e-book reader or another device to access functions provided by the e-book service. The user account management module 310 stores account information (e.g., login name, password) in the data store 350.

The account information includes a collection of e-books that the user owns (also called the user's “personal library shelf”). An e-book on the personal library shelf can be a published e-book provided by the e-book service to all users or a private document only accessible to the user who provided the private document (or others specified by the user). To distinguish from a published e-book, a private document is also called a “personal document.” For each e-book on a user's personal library shelf, the user account management module 310 maintains an e-book record storing information necessary for creating a seamlessly integrated reading experience of the e-book across different e-book readers (also called the “reading experience information”). An e-book record for a published e-book (also called a “published e-book record”) contains information such as a reference (e.g., a pointer) to a copy of the published e-book, a reading position (e.g., a paragraph identifier or a page identifier) where the user's reading previously ended, and user notes (or annotations). A reference is a value that identifies where a piece of information (e.g., an e-book, an e-book record) is stored. An e-book record for a personal document (also called a “personal e-book record”), similar to a published e-book record, contains a reading position and user notes. Unlike a published e-book record, the personal e-book record also includes a reference to a “shadow e-book” created for the underlying personal document. Because a personal document may not be in a format that can be properly rendered by an e-book reader, the server 120 creates a shadow e-book in an e-book format that is compatible with multiple different types of e-book readers for the personal document, and references the shadow e-book in the personal e-book record created for that personal document. The user account management module 310 stores a user's personal library shelf as a list of references pointing to e-book records of e-books on the user's personal library shelf.

The published e-book management module 320 manages a large collection of published e-books, and permits the users to search for, check out (e.g., purchase), and/or read checked-out e-books in the collection. Once a user checks out a published e-book, the published e-book management module 320 creates a published e-book record for that user, and adds the e-book onto the user's personal library shelf by adding a reference to the published e-book record to the list of references for that user.

The personal e-book management module 330 manages personal documents provided by individual users, and permits the users to read their personal documents as e-books on multiple e-book readers. In one embodiment, the personal e-book management module 330 publishes a web interface (e.g., a web page) for users to upload documents storing on the users' local hard drives, and stores the received personal documents (e.g., in the data store 350). In one embodiment, the personal e-book management module 330 stores the personal documents in a data storage service such as GOOGLE DOCS. Once a user uploads a personal document, the personal e-book management module 330 creates a personal e-book record for that personal document, and adds the personal document onto the user's personal library shelf by adding a reference to the personal e-book record to the list of references for that user.

As shown, the personal e-book management module 330 includes a format conversion module 335 designed to convert a personal document from its original format into an e-book format. Because a personal document in its original format may not be recognized by an e-book reader, it may be necessary for the format conversion module 335 to convert the personal document from its original format into an e-book format in order for the user to read the personal document on an e-book reader. The converted document, also called the “shadow e-book,” serves as a representation of the corresponding personal document and is provided to an e-book reader when the user requests to read the personal document on the e-book reader. The shadow e-book for a personal document can be created when the personal document is first uploaded. Alternative, the shadow e-book can be created when a user requests to read the personal document on an e-book reader. In one embodiment, the creation and existence of shadow e-books are transparent to the users, because the shadow e-books are created in response to the corresponding personal documents being uploaded (or requested), provided to e-book readers in response to the corresponding personal documents being requested, and share the same contents with the corresponding personal documents.

Depending on where the personal document is stored (e.g., in a web-based data storage service such as GOOGLE DOCS), the format conversion module 335 first retrieves the personal document (e.g., through an API supported by the web-based data storage service) before converting the personal document into the corresponding shadow e-book. In one embodiment, in addition to the personal documents uploaded by the user, the format conversion module 335 creates shadow e-books for all documents accessible by the user via a web-based data storage service.

The reading experience synchronization module (also called the “synchronization module”) 340 provides users with a seamlessly integrated experience of reading e-books across different e-book readers. A user may start off reading an e-book on the user's personal library shelf on a first e-book reader, and then continue reading the same e-book on a second e-book reader. In order for the user to continue reading the e-book on the second e-book reader at the same location in the e-book where the user's reading ended on the first e-book reader, the synchronization module 340 communicates with the e-book readers to synchronize the reading experience information, such as the reading position (e.g., paragraph identifier or page identifiers) and any notes the user made while reading the e-book. Specifically, the synchronization module 340 receives from an e-book reader used by a user to read an e-book during a reading session information about the user's reading experience (i.e., the reading experience information), and stores such information in an e-book record for that e-book in the user's user account. A reading session is a continuous period of time during which a user reads an e-book on an e-book reader. Once the user continues to read that e-book on another (or the same) e-book reader in a subsequent reading session, the synchronization module 340 transmits the stored reading experience information to the e-book reader for it to synchronize with the most recent reading session, such that the user can continue reading the e-book at the same location in the e-book where the user's reading previously ended.

The data store 350 stores data used by the server 120. Examples of such data include the published e-books, the personal documents, the shadow e-books, the e-book records, and the user account information. The data store 350 may be a relational database or any other type of database, or an in-memory data-structure.

### Overview of a Process for Permitting Users to Access Personal Contents Among Multiple E-Book Readers

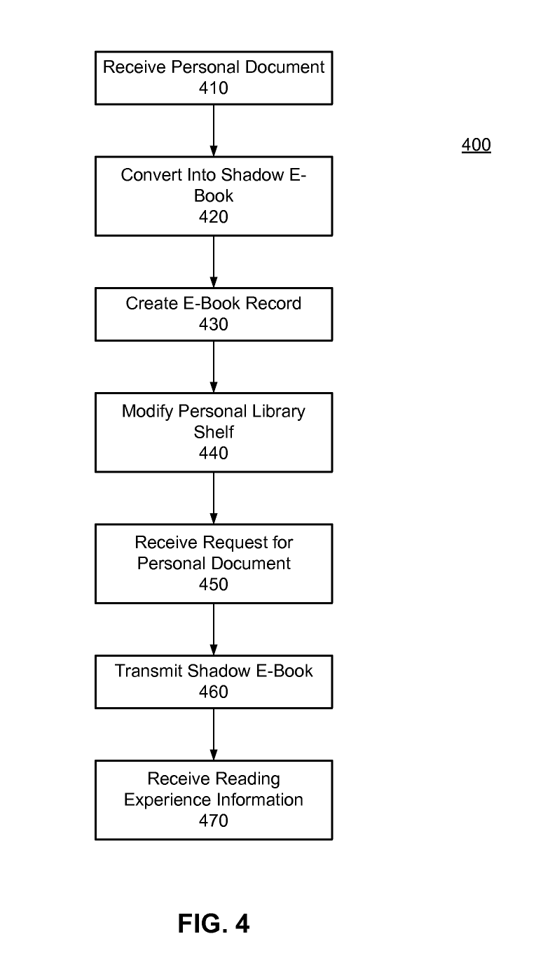

FIG. 4 is a flowchart illustrating a process 400 for the server 120 to permit users to access their own contents among multiple e-book readers, according to one embodiment of the present disclosure. Other embodiments can perform the steps of the process 400 in different orders. Moreover, other embodiments can include different and/or additional steps than the ones described herein.

The server 120 receives 410 a document from a user. For example, the server 120 publishes a web page for users to upload the users' local documents, and receives 410 the document through the web page. The received document (hereinafter called the “personal document”) can be in many different supported formats, such as ePub, PDF, or HTML. The server 120 stores the received personal document in its original format as it was received. In one embodiment, the server 120 stores the personal document in a document service such as GOOGLE DOCS.

The server 120 converts 420 the personal document from its original format into an e-book format (the shadow e-book) and stores a copy of the shadow e-book in the data store 350. In addition, the server 120 creates 430 a personal e-book record for the shadow e-book to store information for creating a seamlessly integrated experience of reading the shadow e-book across different e-book readers. Example information stored in the personal e-book record include the reading position, notes, and a reference (e.g., a pointer) to the personal document and/or the shadow e-book.

The server 120 modifies 440 the user's personal library shelf to include the personal document by adding into a list of references for the personal library shelf a reference to the personal e-book record created 430 for the corresponding shadow e-book. As a result, the personal document is included in the user's personal library shelf along with pre-existing published e-books owned by the user and other previously added personal documents, and the user can access the personal document along with other e-books on the personal library shelf anywhere on any of the user's e-book readers by logging into the user's account with the server 120.

The server 120 receives 450 a request for reading the personal document from a supported e-book reader. The user can own multiple e-book readers and can use any of the e-book readers to read e-books on the user's personal library shelf, such as the personal document, by first logging into the user's account and then selecting the personal document from the personal library shelf

The server 120 transmits 460 the shadow e-book to the e-book reader, along with information from the associated personal e-book record, such that the e-book reader can synchronize with an e-book reader the user previously used to read the personal document (if any) in the most recent reading session and provide the user with a seamlessly integrated reading experience of the personal document between the two reading sessions. Example information from the personal e-book record that is transmitted to the e-book reader include the reading position where the user previously ended the reading session and any notes the user previously made while reading the personal document. The e-book reader can use the received information to jump to the latest page of the shadow e-book where the user ended the previous reading session and/or display user notes, such that the user can seamlessly continue the reading experience of the personal document on the e-book reader.

The server 120 receives 470 user information about the reading experience from the e-book reader (e.g., a new reading position and new notes), and stores the received information in the personal e-book record for the personal document. The server 120 receives 480 the user information periodically and/or upon the user finishing a reading session of the personal document. The server 120 can continue the process 400 by returning to step 450, such that the user can continue reading the e-book on different e-book readers in subsequent reading sessions.

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for permitting users to access personal content on multiple e-book readers. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein.

What is claimed is:

1. A computer-implemented method for accessing a personal document of a user on a plurality of e-book readers, comprising:
providing the personal document to a first e-book reader in response to receiving a request for the personal document from the first e-book reader;
receiving reading experience information for the personal document from the first e-book reader; and
providing the personal document and the reading experience information to a second e-book reader in response to receiving a request for the personal document from the second e-book reader.

2. The method of claim 1, further comprising:
converting the personal document from its original format into a shadow e-book in an e-book format, wherein the original format is not compatible with the first e-book reader and the e-book format is compatible with the first e-book reader and the second e-book reader;
providing the shadow e-book to the first e-book reader; and
providing the shadow e-book and the reading experience information to the second e-book reader.

3. The method of claim 2, further comprising:
creating a first e-book record for the personal document, the first e-book record comprising the reading experience information and a reference to the shadow e-book; and
storing on a non-transitory computer-readable storage medium the first e-book record and a second e-book record for a published e-book owned by the user, wherein the second e-book record comprises reading experience information associated with the published e-book and a reference to the published e-book.

4. The method of claim 2, further comprising:
storing the personal document using a data storage service; and
retrieving the personal document from the data storage service.

5. The method of claim 2, wherein the personal document in the original format is converted into the shadow e-book in the e-book format in response to receiving the personal document from the user.

6. The method of claim 2, wherein the personal document in the original format is converted into the shadow e-book in the e-book format in response to receiving the request for the personal document from the first e-book reader.

7. The method of claim 1, wherein receiving the reading experience information comprises receiving a reading position, and providing the reading experience information to the second e-book reader comprises providing the reading position.

8. The method of claim 1, wherein receiving the reading experience information comprises receiving a note made by the user on the first e-book reader while reading the personal document, and providing the reading experience information to the second e-book reader comprises providing the note.

9. A computer system for accessing a personal document of a user on a plurality of e-book readers, comprising:
a computer-readable storage medium comprising executable computer program code for:
providing the personal document to a first e-book reader in response to receiving a request for the personal document from the first e-book reader,
receiving reading experience information for the personal document from the first e-book reader, and
providing the personal document and the reading experience information to a second e-book reader in response to receiving a request for the personal document from the second e-book reader; and
a processor for executing the executable computer program code.

10. The computer system of claim 9, wherein the computer-readable storage medium further comprises executable computer program code for:
converting the personal document from its original format into a shadow e-book in an e-book format, wherein the original format is not compatible with the first e-book reader and the e-book format is compatible with the first e-book reader and the second e-book reader;
providing the shadow e-book to the first e-book reader; and
providing the shadow e-book and the reading experience information to the second e-book reader.

11. The computer system of claim 10, wherein the computer-readable storage medium further comprises executable computer program code for:
creating a first e-book record for the personal document, the first e-book record comprising the reading experience information and a reference to the shadow e-book; and
storing on a non-transitory computer-readable storage medium the first e-book record and a second e-book record for a published e-book owned by the user, wherein the second e-book record comprises reading experience information associated with the published e-book and a reference to the published e-book.

12. The computer system of claim 10, wherein the computer-readable storage medium further comprises executable computer program code for:
storing the personal document using a data storage service; and
retrieving the personal document from the data storage service.

13. The computer system of claim 10, wherein the personal document in the original format is converted into the shadow e-book in the e-book format in response to receiving the personal document from the user.

14. The computer system of claim 10, wherein the personal document in the original format is converted into the shadow e-book in the e-book format in response to receiving the request for the personal document from the first e-book reader.

15. The computer system of claim 9, wherein receiving the reading experience information comprises receiving a reading position, and providing the reading experience information to the second e-book reader comprises providing the reading position.

16. The computer system of claim 9, wherein receiving the reading experience information comprises receiving a note made by the user on the first e-book reader while reading the personal document, and providing the reading experience information to the second e-book reader comprises providing the note.

17. A non-transitory computer-readable storage medium storing executable computer program instructions for accessing a personal document of a user on a plurality of e-book readers, the computer program instructions comprising instructions for:
providing the personal document to a first e-book reader in response to receiving a request for the personal document from the first e-book reader;
receiving reading experience information for the personal document from the first e-book reader; and
providing the personal document and the reading experience information to a second e-book reader in response to receiving a request for the personal document from the second e-book reader.

18. The storage medium of claim 17, wherein the computer program instructions further comprise instructions for:
converting the personal document from its original format into a shadow e-book in an e-book format, wherein the original format is not compatible with the first e-book reader and the e-book format is compatible with the first e-book reader and the second e-book reader;
providing the shadow e-book to the first e-book reader; and
providing the shadow e-book and the reading experience information to the second e-book reader.

19. The storage medium of claim 18, wherein the computer program instructions further comprise instructions for:
creating a first e-book record for the personal document, the first e-book record comprising the reading experience information and a reference to the shadow e-book; and
storing on a non-transitory computer-readable storage medium the first e-book record and a second e-book record for a published e-book owned by the user, wherein the second e-book record comprises reading experience information associated with the published e-book and a reference to the published e-book.

20. The storage medium of claim 18, wherein the computer program instructions further comprise instructions for:
storing the personal document using a data storage service; and
retrieving the personal document from the data storage service.
